(19) United States
(12) Patent Application Publication
(10) Pub. No.: US 2015/0130686 A1
(43) Pub. Date: May 14, 2015

(54) CASCADED DISPLAYS

(71) Applicant: Bose Corporation, Framingham, MA (US)

(72) Inventor: Mark R. Hickman, Westborough, MA (US)

(73) Assignee: Bose Corporation, Framingham, MA (US)

(21) Appl. No.: 14/075,646

(22) Filed: Nov. 8, 2013

(51) Int. Cl. G09G 3/00; G09G 3/36; G09G 3/32

(52) U.S. Cl. CPC G09G 3/003; G09G 3/3208; G09G 3/36; G09G 2300/023; G09G 2320/0613; G09G 2320/0686; G09G 2320/10; G09G 2340/14
USPC 345/5; 345/4

(57) ABSTRACT

A cascaded display includes multiple transmitting elements which may include superimposed transparent display panels and backlighting elements. Combinations of different display panels may be used for different types of data, e.g., a persistent data panel and a non-persistent data panel to provide more uniform luminosity at any given point in time. Backlighting may be used to alter the color in which the displayed data is perceived by a viewer.

### BACKGROUND

This disclosure relates generally to electronic displays.

### SUMMARY

In accordance with an aspect, an apparatus comprises: a display device comprising: a first display panel on which information of a first type is displayed; and a second display panel on which information of a second type is displayed, the second display panel being optically transparent and superimposed over the first display panel.

In some implementations the first type of information and the second type of information differ in persistence.

In some implementations the first type of information and the second type of information are different types of information selected from: persistent information and non-persistent information.

In some implementations the persistent information includes one or more of: time of day, date, alarm status, alarm time, and a feature status icon.

In some implementations the non-persistent information includes one or more of: audio source identifier, track number, track title, album title, artist name, genre name, audio metadata, volume level, source present number, and audio equalization mode.

In some implementations the first display panel includes at least one of: an organic light emitting diode panel, a liquid crystal display panel, a direct light emitting diode display panel, a plasma display panel, and an electroluminescent display panel.

In some implementations the second display panel includes an organic light emitting diode panel.

In some implementations the second display panel includes a liquid crystal display panel.

In some implementations a region of the display device presents only information of the first type in a first mode, and further presents only information of the second type in a second mode.

In accordance with an aspect an apparatus comprises: a display device comprising: a backlighting element which provides backlighting in a first wavelength range; and a first display panel on which information is displayed, the first display panel being optically transparent, superimposed over the backlighting element, and displaying information in a second wavelength range, different from the first wavelength range.

In some implementations the first display panel includes at least one of: an organic light emitting diode panel and a liquid crystal display panel.

In some implementations the backlighting element includes at least one of: a diffuser, a light emitting diode matrix, an electroluminescent panel, a cold cathode fluorescent lamp, a hot cathode fluorescent lamp, and external electrode fluorescent lamps.

In some implementations the first wavelength range is within 450-495 nm.

In some implementations the second wavelength range is within 590-620 nm.

In some implementations the apparatus comprises a second optically transparent display panel superimposed over the first display panel.

In some implementations information of a first type is displayed on the first display panel, and information of a second type is displayed on the second display panel.

In some implementations the first type of information and the second type of information differ in persistence.

In some implementations the first type of information and the second type of information are different types of information selected from: persistent information and non-persistent information.

In some implementations the persistent information includes one or more of: time of day, date, alarm status, alarm time, and a feature status icon.

In some implementations the non-persistent information includes one or more of: audio source identifier, track number, track title, album title, artist name, genre name, audio metadata, and volume level, source preset number, and audio equalization mode.

In some implementations the second display panel comprises an organic light emitting diode panel.

In some implementations the second display panel includes a liquid crystal display panel.

In some implementations a region of the display device presents only information of the first type in a first mode, and further presents only information of the second type in a second mode.

In accordance with an aspect a display device comprises: a backlighting element which provides backlighting in a first wavelength range; a first display panel on which information is displayed, the first display panel being optically transparent, superimposed over the backlighting element, and displaying information in a second wavelength range, different from the first wavelength range; and a second optically transparent display panel superimposed over the first display panel.

### BRIEF DESCRIPTION OF THE FIGURES

FIG. 1 illustrates a display which includes cascaded panels.

FIG. 2 illustrates rendering of different types of data in different operational modes with the display of FIG. 1.

FIG. 3 illustrates layers of a display which includes cascaded OLED panels.

FIG. 4 illustrates a method for operating a display such as the display of FIG. 1.

FIG. 5 illustrates a display which includes a panel cascaded with backlighting.

FIG. 6 illustrates rendering of data with the display of FIG. 5.

FIG. 7 illustrates a display which includes cascaded panels and backlighting.

FIG. 8 illustrates rendering of different types of data in different operational modes with the display of FIG. 7.

### DETAILED DESCRIPTION

All examples, features and aspects can be combined in any technically possible way. For purposes of illustration some elements are omitted from the illustrated views and some dimensions are exaggerated.

Displays are used with a wide variety of devices including but not limited to consumer appliances. For example and without limitation, a display can be used to present operational status, settings, video and other information. Some displays are active only when the associated device is in an active mode. However, displays may also be used to present information when the associated device is in a passive mode. For example, the display might be used to present information such as time of day, date, and certain device settings when the device is not in the active mode or when the display is not being used to present other information. Many devices are maintained in the passive mode for greater amounts of time than in the active mode. The information presented on the display can thus be generally categorized into one of two types based on the duty cycle of the device. For example, information that is presented for relatively more time and for longer durations of time when the device is in the passive mode can be considered persistent information. Information that is presented for relatively less time and for shorter durations of time when the device is in the active mode can be considered non-persistent information. For example, an audio appliance may present persistent clock information when in a passive mode, and present non-persistent operational status information in an active mode. Such operational status information may include an audio source identifier (e.g., terrestrial or internet radio station), track number, track title, album title, artist name, genre name, and/or any applicable audio metadata. Operational status information may also include volume level, a source preset number, and/or audio equalization mode (e.g., music, movie, or talk). It should be understood that persistent information is not necessarily static, e.g., the time of day presented on the clock changes over time. However, when the persistent information is presented in a static location of the display there is typically an imbalance in the amount of time that certain regions of the display are active, e.g., certain pixels may experience much more use than other pixels. This can be problematic because the luminescence of pixels may degrade over time as a function of use. The problem can be manifested as ghosting or burn-in. For example, a ghost image of a clock may be presented in the image of other information because the pixels used for the clock have degraded luminosity and consequently are not as bright as adjacent pixels which are not used for the clock.

A variety of different display technologies are known. Examples include but are not limited to cathode ray tube (CRT), direct light emitting diode (LED), organic light emitting diode (OLED), liquid crystal display (LCD), plasma, and electroluminescent display panels. Most or all display technologies exhibit luminosity degradation as a function of use, albeit not necessarily to the same degree. Another characteristic of certain displays such as OLED and LCD displays is that they can be transparent. In particular, these displays can present images in a first mode and appear to be clear in a second mode such that objects behind the display can be seen through the display by an observer position in front of the display. Moreover, in both the first and second modes these displays allow light to traverse the display.

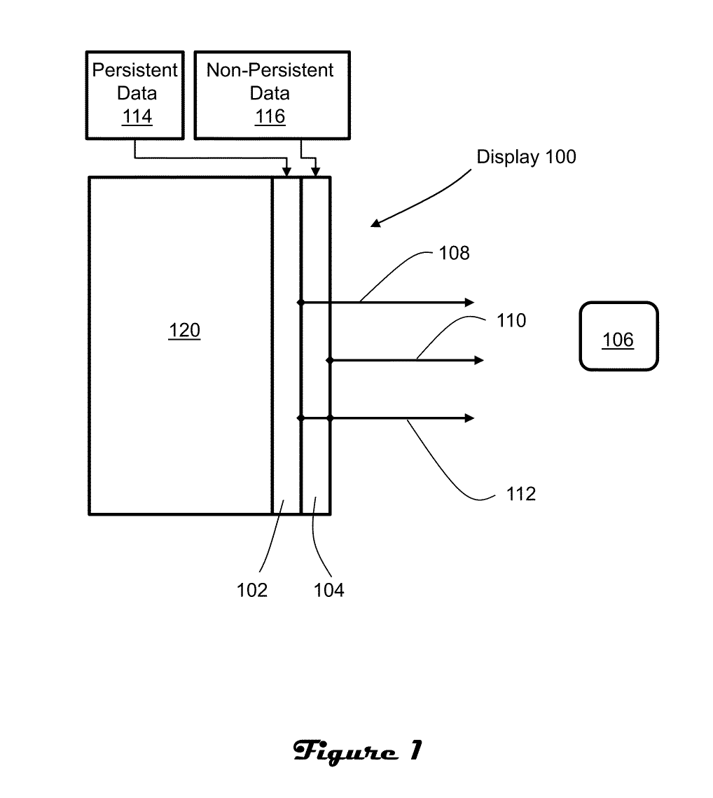

Referring now to FIG. 1, a cascaded display 100 includes superimposed display panels 102, 104. Panel 102 can be any type of display panel, e.g., CRT, LED, OLED, LCD, plasma, electroluminescent and any other suitable technology. In some examples, panel 104 is based on a technology such as OLED or LCD which permits passage of light therethrough. Panel 104 is at least partially superimposed over panel 102. A pixel 108 presented by the display 100 may include a contribution from panel 102 which is observable through transparent panel 104. Another pixel 110 presented on the display may include a contribution from panel 104, and another pixel 112 may include contributions from both panel 102 and panel 104. Consequently, an observer at position 106 can view an image presented on panel 102, an image presented on panel 104, or a combination of images presented on both panel 102 and panel 104 at a given point in time.

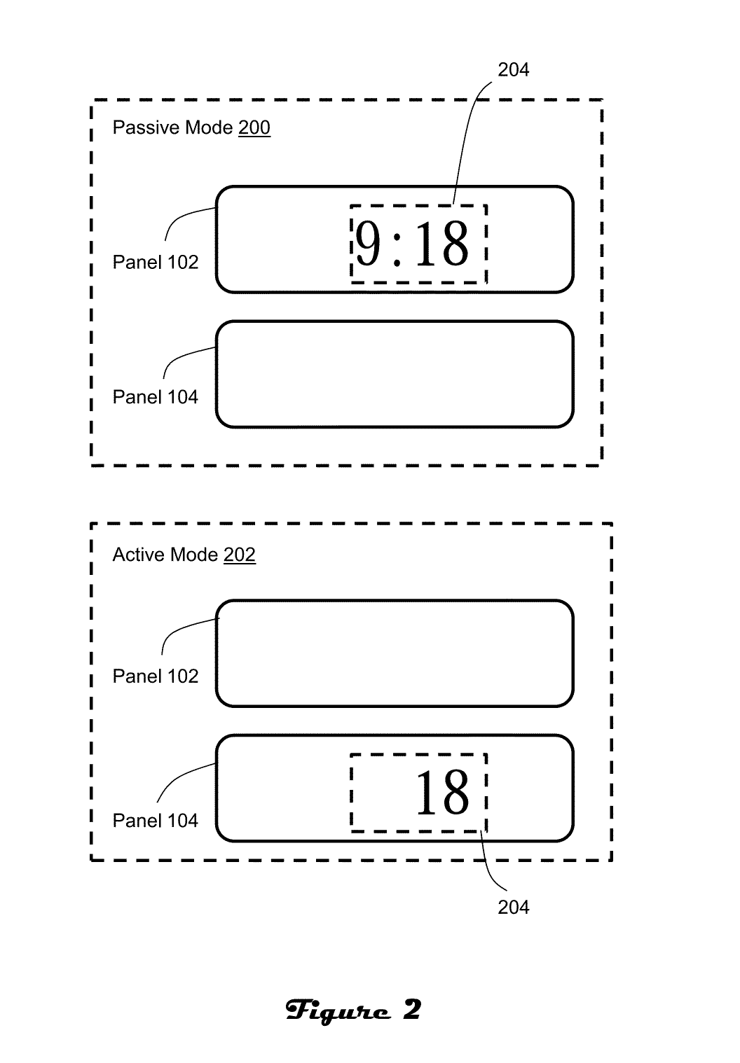

Referring now to FIGS. 1 and 2, each panel or a region thereof down to the level of an individual pixel may be dedicated to presentation of a predetermined type of information. For example, a first type of data such as data 114 associated with persistent information might be presented on panel 102, and a second type of data such as data 116 associated with non-persistent information might be presented on panel 104. This association of different types of data with different panels based on information type can help to avoid ghosting and problems related to luminosity degradation by avoiding use of particular pixels for presentation of both persistent and non-persistent information. In the illustrated example, panel 102 presents clock data (persistent information) and panel 104 is in the transparent mode when the audio appliance 120 is in a passive mode 200. When the audio appliance is switched to an active mode 202, panel 102 does not present data and panel 104 presents non-persistent information such as operational status. In a region 204 of overlap where ghosting or a difference in luminosity might otherwise occur, the non-persistent information is presented without ghosting or luminosity variation because panel 104 is utilized rather than panel 102. For example, although the number “18” is presented in the same position in both modes, panel 102 is used to present the number “18” when it is associated with persistent clock information and panel 104 is used to present the number “18” when it is associated with non-persistent track number information. However, it should be understood that panel 102 could be utilized for non-persistent information while panel 104 could be utilized for persistent information. Moreover, while the foregoing example describes the panels 702, 704 presenting the number “18” in the same position for both modes, the information presented may also include graphics, iconography, symbols, images, letters, and/or any combination thereof. Further, persistent and non-persistent information could be presented contemporaneously in different regions of the display, and regions of panels down to the level of individual pixels could be dedicated to presentation of certain types of information rather than entire panels.

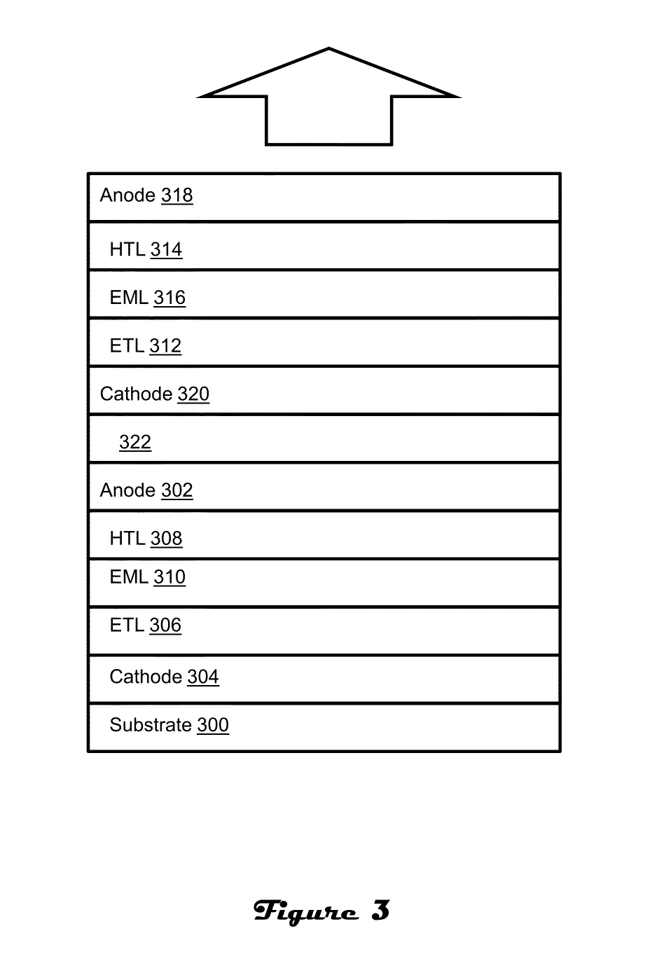

FIG. 3 illustrates layers of a display having cascaded OLED panels according to one example. The panels may be deposited on a substrate 300. A first OLED panel corresponding to panel 102 (FIGS. 1 and 2) includes three organic layers between an anode layer 302 and a cathode layer 304. The organic layers include an electron transport layer (ETL) 306, a hole transport layer (HTL) 308, and an emissive layer (EML) 310. A second OLED panel corresponding to panel 104 (FIGS. 1 and 2) includes an ETL 312, HTL 314 and EML 316 between an anode layer 318 and a cathode layer 320. A separation layer 322 may be disposed between the cathode layer 320 of the second OLED panel and the anode layer 302 of the first OLED panel.

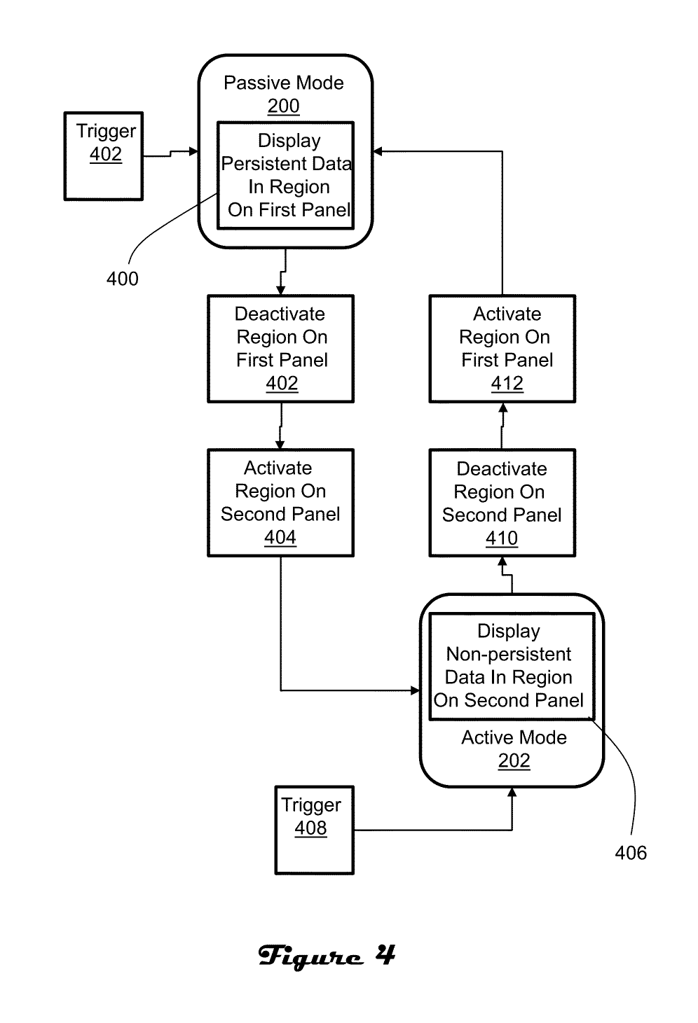

FIG. 4 illustrates a method for operating a display such as the display of FIGS. 1 and 2. When the device is in the passive mode 200 the display is used to present persistent type data in a predetermined region of a first panel (e.g., panel 102) as indicated in step 400. The region may be a particular pixel, group of pixels or any other area up to and including the entire panel. In response to a trigger 402, the device transitions into the active mode 202. The trigger 402 can include any of a wide variety of inputs and conditions, including but not limited to, user input and predetermined conditions such as an alarm based on time of day. In response to the trigger 402, the region is deactivated on the first panel as indicated in step 402. In other words, the first panel ceases to display the persistent type data in the region. The region is then activated on the second panel as indicated in step 404. The device then displays non-persistent type data in the region on the second panel as indicated in step 406. In response to another trigger 408, which could include any of a wide variety of inputs and conditions, the device transitions from the active mode 202 to the passive mode 200. In order to transition into the passive mode, the region is deactivated on the second panel as indicated in step 410. In other words, the second panel ceases to display the non-persistent type data in the region. The region is then activated on the first panel as indicated in step 412. The display then presents persistent type data in the region on the first panel as indicated in step 400. These transitions may occur many times during the life cycle of the device, and it should be appreciated that some of the illustrated steps may occur contemporaneously or in an order different from that shown in FIG. 4.

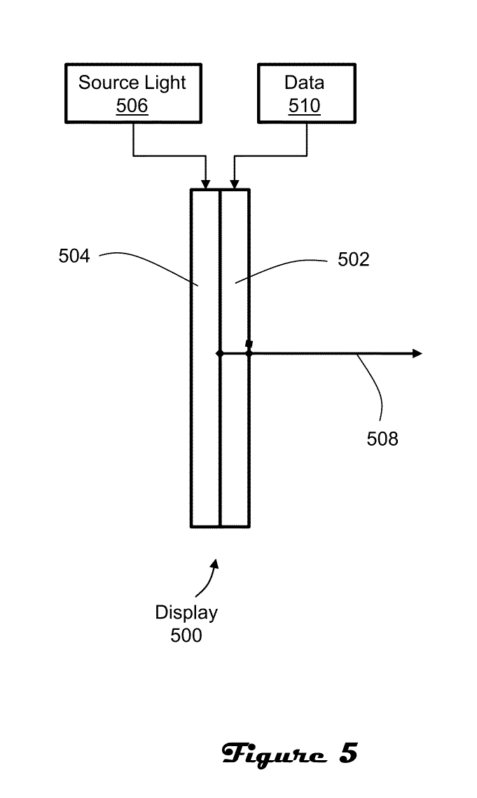

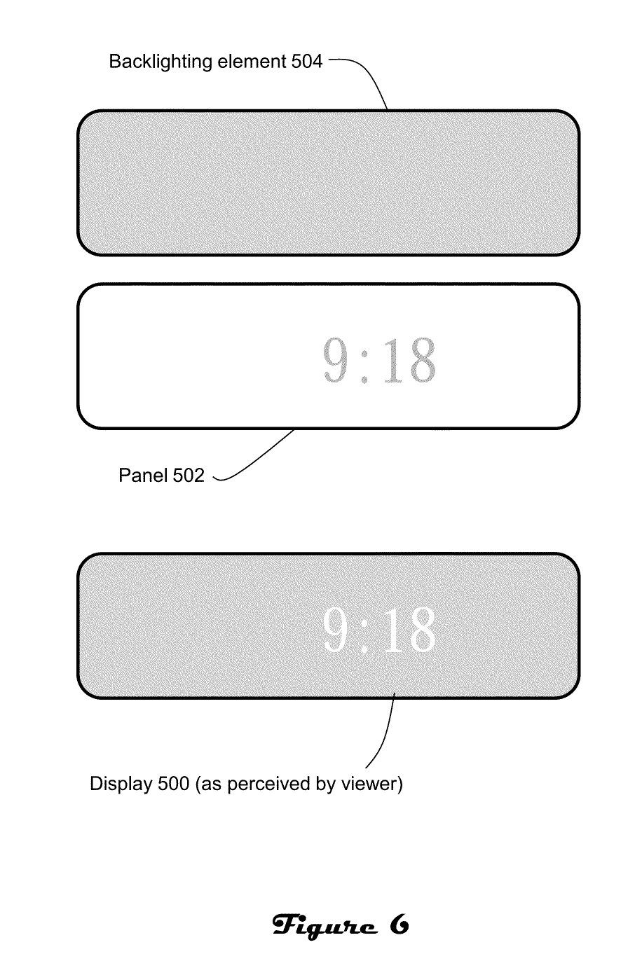

Referring to FIGS. 5 and 6, a display 500 may include a transparent display panel 502 cascaded with a backlighting element 504. The backlighting element 504 could include a diffuser, a light emitting diode matrix, an electroluminescent panel, a cold cathode fluorescent lamp, a hot cathode fluorescent lamp, external electrode fluorescent lamps, and any other suitable technology. The display panel 502 could include an OLED display, LCD display or display panel based on any other technology that permits light from the backlighting element to pass through the panel. The backlighting element, which may or may not utilize source light 506, presents light in a predetermined region defined by a pixel or group of pixels up to and including the entire backlighting element. The display panel 502 is at least partially superimposed over the backlighting element 504. A pixel 508 presented by the display represents a combination of a contribution from the backlighting element and a contribution from the panel. Consequently, when data 510 is presented on the panel in a different spectral range than the light presented by the backlighting element 504 a viewer may then perceive the data to be presented in a different spectral range due to the phenomenon of color addition. For example, the backlighting element 504 could transmit in a first wavelength range 450-495 nm (blue light) and the panel 502 could display the data in a second wavelength range 570-590 nm (yellow light) or 590-620 nm (orange light), resulting in a viewer perceiving the data to be presented on display 500 in white on a blue background. However, these ranges are simply examples and neither the backlighting element 504 nor the panel 502 is necessarily monochromatic. Because different colors may be subject to different rates of luminosity degradation, this configures the display to present data in colors with longer lasting levels of luminosity while the observer perceives the data to be presented in a different color that would be associated with a higher rate of luminosity degradation if actually presented in that color.

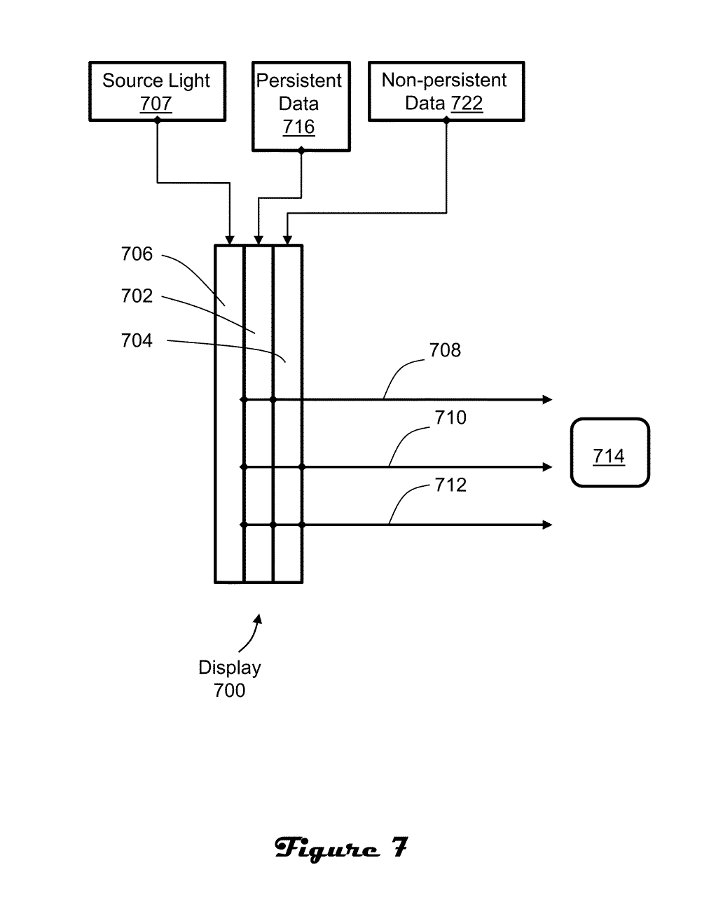

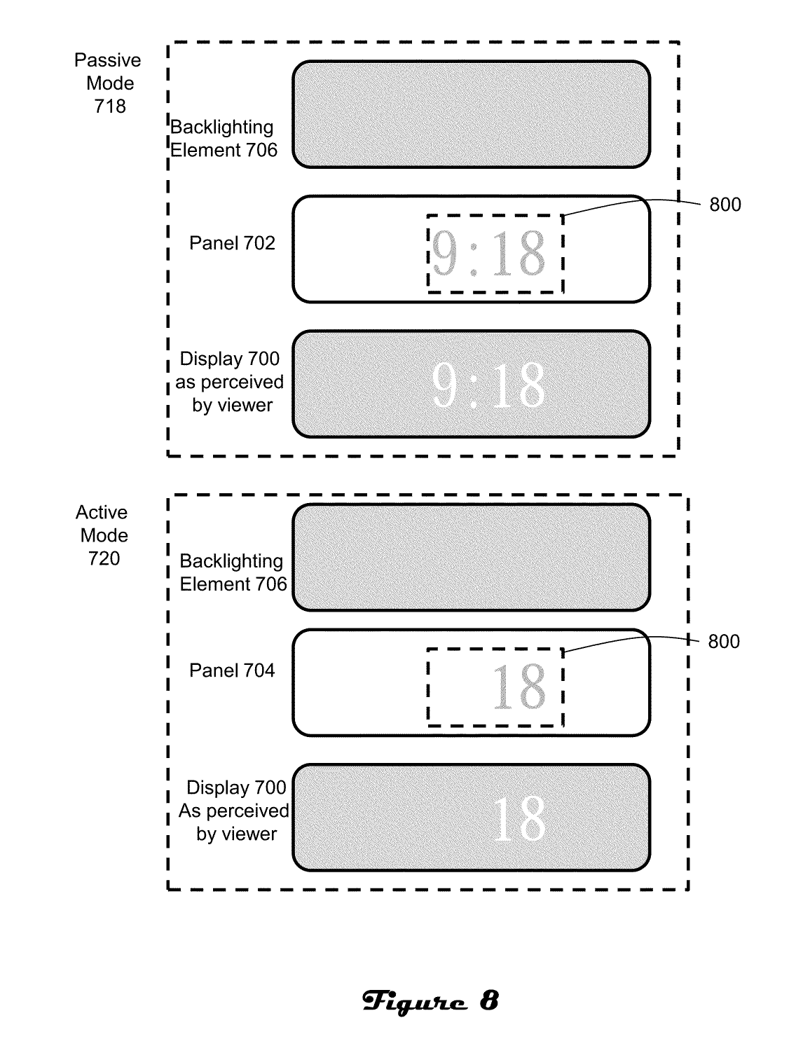

FIGS. 7 and 8 illustrate a display 700 which includes cascaded panels and a backlighting element. In particular, a first transparent display panel 704 is superimposed over a second transparent display panel 702 and a backlighting element 706. The panels 704, 702 are transparent panels such as OLED display, LCD displays, or any other suitable display technology. The backlighting element, which may or may not utilize source light 707, could include a diffuser, a light emitting diode matrix, an electroluminescent panel, a cold cathode fluorescent lamp, a hot cathode fluorescent lamp, external electrode fluorescent lamps, or any other suitable technology. A pixel 708 presented by the display 700 may include a contribution from the backlighting element 706 and second transparent panel 702 which is observable through first transparent panel 704. Another pixel 710 presented on the display may include a contribution from the backlighting element 706 and panel 704, and another pixel 712 may include contributions from the backlighting element 706 and both panel 702 and panel 704. Consequently, an observer at position 714 can view an image presented on panel 702, an image presented on panel 704, or a combination of images presented on both panel 702 and panel 704 at a given point in time. Moreover, the panels 702, 704 or regions thereof down to the level of individual pixels may be dedicated to presentation of predetermined types of information, and the perceived coloration in which that information is presented can be modified by the backlighting element as a result of the phenomenon of color addition. In the illustrated example, panel 702 presents persistent clock data 716 and panel 704 transmits no signal in the transparent mode when the audio appliance is in a passive mode 718. When the audio appliance is switched to an active mode 720, panel 702 transmits no signal and panel 704 presents non-persistent data 722 such as operational status. The backlighting element could transmit in a first wavelength range 450-495 nm (blue light) and the panels 702, 704 could present data in a second wavelength range 570-590 nm (yellow light) or 590-620 nm (orange light), resulting in a viewer perceiving both the persistent information and non-persistent information to be presented in white on a blue background. However, these ranges are simply examples and neither the backlighting element nor panel is necessarily monochromatic. In a region 800 of overlap where ghosting or a difference in luminosity might otherwise occur, the non-persistent data is presented without ghosting or luminosity variation because panel 704 is utilized rather than panel 702. For example, although the number “18” is presented in the same position in both modes, panel 702 is used to present the number “18” when it is associated with persistent clock information and panel 704 is used to present the number “18” when it is associated with non-persistent track number information. However, it should be understood that panel 702 could be utilized for non-persistent information while panel 704 could be utilized for persistent information. Moreover, while the foregoing example describes the panels 702, 704 presenting the number “18” in the same position for both modes, the information presented may also include graphics, iconography, symbols, images, letters, and/or any combination thereof. Further, persistent and non-persistent information could be presented contemporaneously in different regions of the display, and regions of panels down to the level of individual pixels could be dedicated to presentation of certain types of information rather than entire panels.

A number of implementations have been described in the above examples, but it will be understood by those of ordinary skill in the art that a wide variety of modifications and variations are possible without departing from the concepts herein disclosed. Moreover, all examples, features and aspects can be combined in any technically possible way. Accordingly, other implementations are within the scope of the following claims.

What is claimed is:

1. An apparatus comprising:
a display device comprising:
a first display panel on which information of a first type is displayed; and
a second display panel on which information of a second type is displayed, the second display panel being optically transparent and superimposed over the first display panel.

2. The apparatus of claim 1 wherein the first type of information and the second type of information differ in persistence.

3. The apparatus of claim 1 wherein the first type of information and the second type of information are different types of information selected from: persistent information and non-persistent information.

4. The apparatus of claim 3 wherein the persistent information includes one or more of: time of day, date, alarm status, alarm time, and a feature status icon.

5. The apparatus of claim 3 wherein the non-persistent information includes one or more of: audio source identifier, track number, track title, album title, artist name, genre name, audio metadata, volume level, source present number, and audio equalization mode.

6. The apparatus of claim 1 wherein the first display panel includes at least one of: an organic light emitting diode panel, a liquid crystal display panel, a direct light emitting diode display panel, a plasma display panel, and an electroluminescent display panel.

7. The apparatus of claim 1 wherein the second display panel includes an organic light emitting diode panel.

8. The apparatus of claim 1 wherein the second display panel includes a liquid crystal display panel.

9. The apparatus of claim 1 wherein a region of the display device presents only information of the first type in a first mode, and further presents only information of the second type in a second mode.

10. An apparatus comprising:
a display device comprising:
a backlighting element which provides backlighting in a first wavelength range; and
a first display panel on which information is displayed, the first display panel being optically transparent, superimposed over the backlighting element, and displaying information in a second wavelength range, different from the first wavelength range.

11. The apparatus of claim 10 wherein the first display panel includes at least one of: an organic light emitting diode panel and a liquid crystal display panel.

12. The apparatus of claim 10 wherein the backlighting element includes at least one of: a diffuser, a light emitting diode matrix, an electroluminescent panel, a cold cathode fluorescent lamp, a hot cathode fluorescent lamp, and external electrode fluorescent lamps.

13. The apparatus of claim 10 wherein the first wavelength range is within 450-495 nm.

14. The apparatus of claim 10 wherein the second wavelength range is within 590-620 nm.

15. The apparatus of claim 10 further comprising a second optically transparent display panel superimposed over the first display panel.

16. The apparatus of claim 15 wherein information of a first type is displayed on the first display panel, and information of a second type is displayed on the second display panel.

17. The apparatus of claim 16 wherein the first type of information and the second type of information differ in persistence.

18. The apparatus of claim 17 wherein the first type of information and the second type of information are different types of information selected from: persistent information and non-persistent information.

19. The apparatus of claim 18 wherein the persistent information includes one or more of: time of day, date, alarm status, alarm time, and a feature status icon.

20. The apparatus of claim 18 wherein the non-persistent information includes one or more of: audio source identifier, track number, track title, album title, artist name, genre name, audio metadata, and volume level, source preset number, and audio equalization mode.

21. The apparatus of claim 15 wherein the second display panel comprises an organic light emitting diode panel.

22. The apparatus of claim 15 wherein the second display panel includes a liquid crystal display panel.

23. The apparatus of claim 15 wherein a region of the display device presents only information of the first type in a first mode, and further presents only information of the second type in a second mode.

24. A display device comprising:
a backlighting element which provides backlighting in a first wavelength range;
a first display panel on which information is displayed, the first display panel being optically transparent, superimposed over the backlighting element, and displaying information in a second wavelength range, different from the first wavelength range; and
a second optically transparent display panel superimposed over the first display panel.
